(19) United States
(12) Patent Application Publication
(10) Pub. No.: US 2023/0265678 A1
(43) Pub. Date: Aug. 24, 2023

(54) UNIVERSAL ADAPTOR FOR DOOR HANDLE

(71) Applicant: Shanghai Ming Wei Hardware Co., Ltd., Shanghai (CN)

(72) Inventors: JUNG-CHUNG CHEN, Shanghai (CN); PEI-QI CHEN, Shanghai (CN)

(21) Appl. No.: 17/728,863

(22) Filed: Apr. 25, 2022

(30) Foreign Application Priority Data
Feb. 23, 2022 (CN) 202210169937.6

(51) Int. Cl. E05B 3/00

(52) U.S. Cl. CPC E05B 3/00

(57) ABSTRACT

A universal adaptor for door handle, operable to be universally assembled in a polygonal assembling groove of one of multiple types of handles, so that the above-mentioned handle forms a panel-like lock handle and is locked to a panel lock, and includes a lock portion and a universal extension portion. The lock portion is formed with at least one lock hole corresponding to the panel lock. The universal extension portion is connected to the lock portion and extends along an extension direction to form a polygonal rod structure, and a catching-type fit relationship is formed between the polygonal rod structure and the polygonal assembling groove. The present disclosure can achieve the functions and effects of universally assembling in polygonal assembling grooves of handles with different appearances and thereby enabling the handles to be locked to panel locks.

### CROSS REFERENCE TO RELATED APPLICATIONS

This application claims priority to Chinese Patent Application No. 202210169937.6, filed on Feb. 23, 2022, which is hereby incorporated by reference in its entirety.

### TECHNICAL FIELD

The present disclosure relates an adaptor, in particular to a universal adaptor capable of universally applying to multiple types of door handle.

### BACKGROUND

Doors are an indispensable building material in daily life, people are constantly in contact with doors from morning to night, such as: room doors, toilet doors, house doors, office doors, etc., and most doors are matched with corresponding handles.

Please refer to FIG. 1 to FIG. 3 together, where, FIG. 1 is a perspective view showing a handle in the prior art; FIG. 2 is an explosive view showing the handle and the door in FIG. 1; and FIG. 3 is a perspective view showing another handle in the prior art. As shown in the figures, a handle PA1a has a polygonal assembling groove Ta.

The handle PA1a is connected to the inside of a door D by using a connecting piece B, in this embodiment, the handle PA1a is further connected to the connecting piece B by using a ring buckle C. There are many types of appearance of such handle, please refer to FIG. 3, which is another handle PA1b in the prior art. The handle PA1b also has a polygonal assembling groove Tb, but its appearance is different from the handle PA1a. In general, the above-mentioned handles (handles PA1a, PA1b) are very common handles in the market, and usually moves together with a lock box inside the door D by matching with a square shaft (not shown in the figures).

The handle PA1a, the connecting piece B, the ring buckle C, the door D, the square shaft and the lock box are common knowledge belonging to the technical art, therefore the accompanying drawings are for illustration only, details will not be repeated.

Please refer to FIG. 4 to FIG. 6 together, where, FIG. 4 is a perspective view showing a panel lock handle in the prior art; FIG. 5 is an explosive view showing the panel lock handle and the door in FIG. 4; and FIG. 6 is a perspective view showing another panel lock handle in the prior art. As shown in the figures, a panel lock handle PA2a has multiple lock holes Ha. The panel lock handle PA2a will be locked to a lock pin P of a panel lock L by using the lock holes Ha, and connects with the door D. Usually, the panel lock L has a mechanism inside which moves together with the lock box inside the door D. There may be also many types of appearance of such panel lock handle, please refer to FIG. 6, which is another panel lock handle PA2b in the prior art. The panel lock handle PA2b also has multiple lock holes Hb, but its appearance is different from the panel lock handle PA2a.

However, the panel lock handles PA2a, PA2b in the prior art are manufactured by integral molding. If different appearances are required, different molds need to be developed and produced according to different appearances. Therefore, in order to meet the needs of the market, a larger development cost need to be borne; moreover, when the quantity demanded of a panel lock handle with one of the appearances is small but has to be developed, the development cost of the panel lock handle with this appearance will bring a burden to the enterprise; besides, in practice, various panel lock handles PA2a, PA2b will also have minimum production requirements, which may result in overstock, thereby resulting in the problem of backlog materials. In addition, common polygonal assembling grooves of the handles cannot be assembled in the panel locks. Thus, there is room for improvement in the prior art.

### SUMMARY

In view of that in the prior art, common polygonal assembling grooves of the handles cannot be assembled in the panel locks, different appearances require correspondingly different molds and different development costs, small quantity demanded makes the development costs a burden, overstock and backlog materials caused by minimum production requirements, and various problems raised from those, all of which are caused by the panel lock handles are manufactured by integral molding. One main purpose of the present disclosure is to provide a universal adaptor for door handle operable to solve at least one of the problems in the prior art.

In order to solve the problems in the prior art, an essential technical means adopted by the present disclosure is to provide a universal adaptor for door handle. The universal adaptor is operable to be universally assembled in a polygonal assembling groove of one of multiple types of handles, so as to make the above-mentioned handle form a panel-like lock handle and be locked to a panel lock, and including a lock portion and a universal extension portion. The lock portion is formed with at least one lock hole corresponding to the panel lock. The universal extension portion is connected to the lock portion, is extended along an extension direction to form a polygonal rod structure, and a catching-type fit relationship is formed between the polygonal rod structure and the polygonal assembling groove.

On the basis of the above-mentioned essential technical means, an additional technical means is to make the universal extension portion in the universal adaptor further including an extension body, and the extension body being a polygonal body structure.

On the basis of the above-mentioned essential technical means, an additional technical means is to make the extension body of the universal adaptor be a rectangular body structure.

On the basis of the above-mentioned essential technical means, an additional technical means is to make the extension body of the universal adaptor further formed with a fixing groove, which is fit for a fixing pin of the above-mentioned handle, and is not parallel to the extension direction.

On the basis of the above-mentioned essential technical means, an additional technical means is to make the extension body of the universal adaptor further formed with multiple snap grooves, and each of the snap grooves being not parallel to the extension direction.

On the basis of the above-mentioned essential technical means, an additional technical means is to make the extension body of the universal adaptor further having a first extension plane, a second extension plane, a third extension plane and a fourth extension plane, and the snap grooves being located on the first extension plane and the second extension plane.

On the basis of the above-mentioned essential technical means, an additional technical means is to make the first extension plane of the universal adaptor be adjacent to the third extension plane and the fourth extension plane, and make the second extension plane be opposite to the first extension plane and being adjacent to the third extension plane and the fourth extension plane.

On the basis of the above-mentioned essential technical means, an additional technical means is to make quantity of the lock holes in the universal adaptor be three, and the three lock holes are arranged along an arrangement direction.

As mentioned above, the universal adaptor for door handle provided by the present disclosure is universally assembled in a polygonal assembling groove of one of multiple types of handles by using the lock portion and the universal extension portion, so as to make the above-mentioned handle form a panel-like lock handle and be locked to a panel lock. Compared with the prior art, the present disclosure can be universally assembled in common handles with polygonal assembling grooves, so as to make the above-mentioned handles form panel-like lock handle and are locked to panel locks, thereby resolving the problem that the handles with polygonal assembling grooves cannot be locked to the panel locks in the prior art, and the problems that different appearances require correspondingly different molds and different development costs, small quantity demanded makes the development costs a burden, overstock and backlog materials caused by minimum production requirements, and various problems raised from those, all of which are caused by the panel lock handles are manufactured by integral molding.

### BRIEF DESCRIPTION OF DRAWINGS

FIG. 1 is a perspective view showing a handle in the prior art;

FIG. 2 is an explosive view showing the handle and the door in FIG. 1;

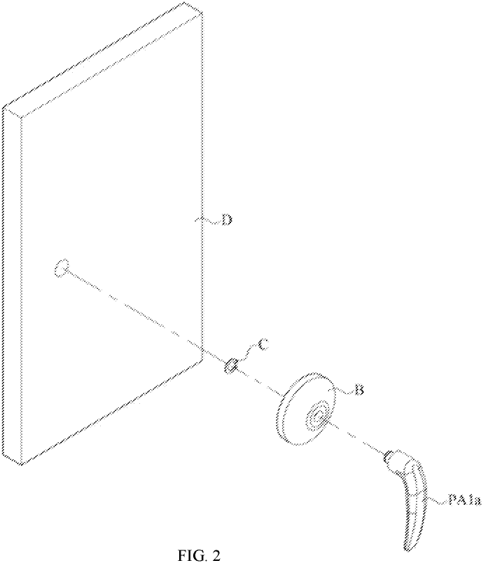

FIG. 3 is a perspective view showing another handle in the prior art;

FIG. 4 is a perspective view showing a panel lock handle in the prior art;

FIG. 5 is an explosive view showing the panel lock handle and the door in FIG. 4;

FIG. 6 is a perspective view showing another panel lock handle in the prior art;

FIG. 7 is a perspective view showing a universal adaptor for door handle provided by a first embodiment of the present disclosure;

FIG. 8 is a perspective view showing a universal adaptor for door handle provided by a second embodiment of the present disclosure;

FIG. 9 is a perspective view showing a universal adaptor for door handle provided by a third embodiment of the present disclosure; and

FIG. 10 is a schematic diagram showing a using state of a universal adaptor for door handle of the present disclosure.

### DESCRIPTION OF EMBODIMENTS

Combining schematic diagrams, embodiments of the present disclosure will be described with more details in the following. Advantages and characteristics of the present disclosure will be clearer according to the following description and the claims. It should be noted that, accompanying drawings all are in a very simplified form and use an inaccurate scale, and are only used to conveniently and explicitly assist the purpose of explain the embodiments of the present disclosure.

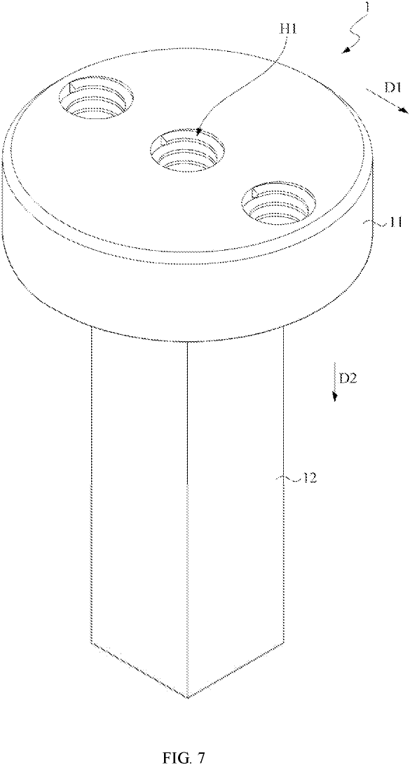

Please refer to FIG. 7, FIG. 7 is a perspective view showing a universal adaptor for door handle provided by a first embodiment of the present disclosure. As shown in the figure, a universal adaptor 1 is capable of universally applying to multiple types of door handle, and includes a lock portion 11 and a universal extension portion 12.

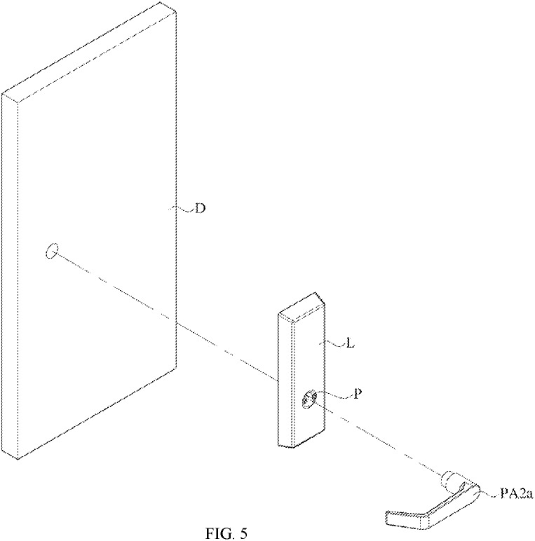

The lock portion 11 is formed with at least one lock hole H1 and is a cylindrical structure. The lock hole H1 will correspond to a lock pin P of a panel lock L as shown in FIG. 5, in this embodiment, quantity of the at least one lock hole H1 is three, and all of them are arranged along an arrangement direction D1, however which will not be limited to this limitation. In other embodiments of the present disclosure, the number of the lock hole H1 may be one, two or other numbers.

The universal extension portion 12 is connected to the lock portion 11 and extends along an extension direction D2 to form a polygonal rod structure, where, the extension direction D2 will not be parallel to the arrangement direction D1. In this embodiment, the extension direction D2 will be substantially perpendicular to the arrangement direction D1. As shown in the figure, the universal extension portion 12 in this embodiment is a quadrangular prism structure, also called a rectangular body structure, which will not be limited to this limitation. The universal extension portion 12 may also be a pentagonal prism structure, a hexagonal prism structure, and so on.

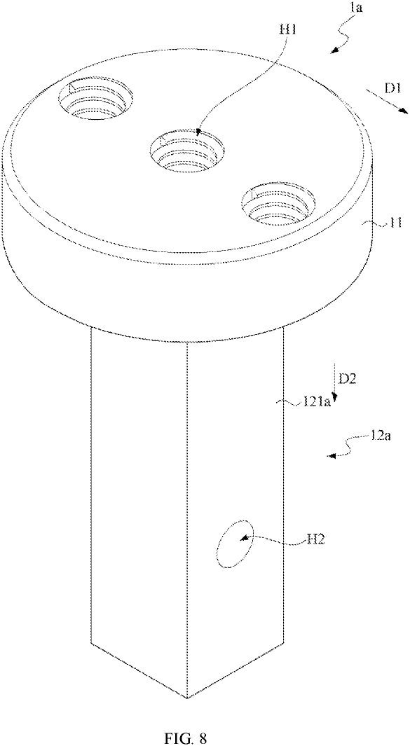

Next, please refer to FIG. 8, FIG. 8 is a perspective view showing a universal adaptor for door handle provided by a second embodiment of the present disclosure. As shown in the figure, a universal adaptor 1a is capable of universally applying to multiple types of door handle, and includes a lock portion 11 and a universal extension portion 12a, where, the lock portion 11 is the same with the lock portion 11 of the first embodiment, thus which will not be repeated here.

The universal extension portion 12a is connected to the lock portion 11 and extends along the extension direction D2 to form a polygonal rod structure, where, the extension direction D2 will not be parallel to the arrangement direction D1. In this embodiment, the universal extension portion 12a further includes an extension body 121a. As shown in the figure, the extension body 121a is the quadrangular prism structure, also called the rectangular body structure, and the extension body 121a is formed with a fixing groove H2.

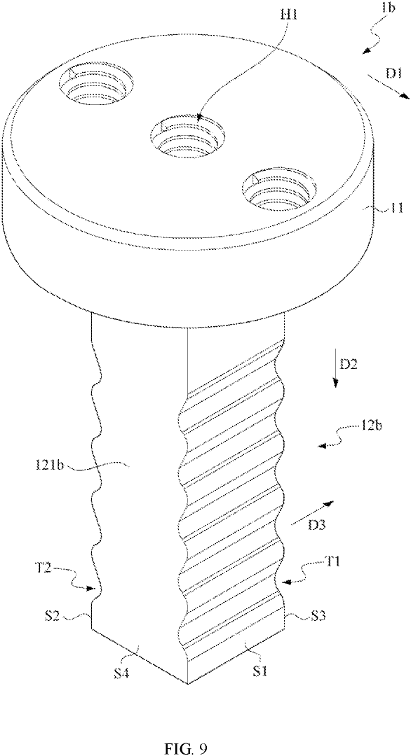

Next, please refer to FIG. 9, FIG. 9 is a perspective view showing a universal adaptor for door handle provided by a third embodiment of the present disclosure. As shown in the figure, a universal adaptor 1b is capable of universally applying to multiple types of door handle, and includes a lock portion 11 and a universal extension portion 12b, where, the lock portion 11 is the same with the lock portion 11 of the first embodiment, thus which will not be repeated here.

The universal extension portion 12b is connected to the lock portion 11 and extended along the extension direction D2 to form a polygonal rod structure, where, the extension direction D2 will not be parallel to the arrangement direction D1. In this embodiment, the universal extension portion 12b further includes an extension body 121b. The extension body 121b is formed with multiple snap grooves T1, T2 (both presented for illustration).

In this embodiment, the extension body 121b has a first extension plane S1, a second extension plane S2, a third extension plane S3 and a fourth extension plane S4, and the first extension plane S1 is opposite to the second extension plane S2, the third extension plane S3 is opposite to the fourth extension plane S4, and the first extension plane S1 is adjacent to the third extension plane S3 and the fourth extension plane S4. The snap groove T1 is formed on the first extension plane S1, and the snap groove T2 is formed on the second extension plane S2, any of the snap grooves T1 and T2 is not parallel to the extension direction D2. In this embodiment, each one of the snap grooves T1 and T2 extends along a first direction D3. And providing the snap grooves T1, T2 on the extension body 121b can be regarded as surface roughening treatment.

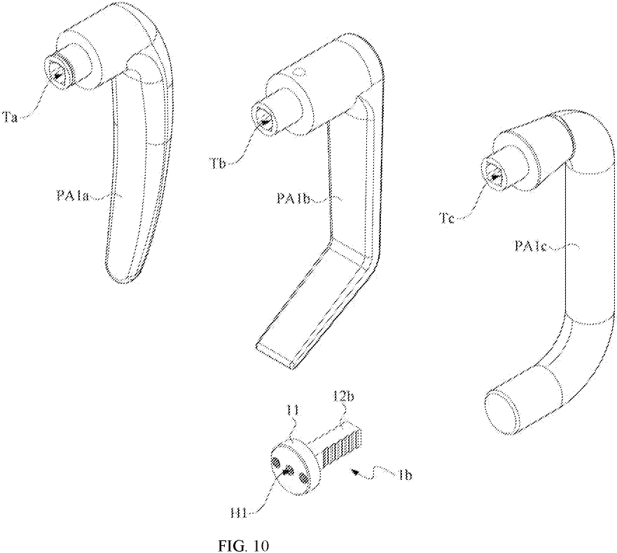

At last, please refer to FIG. 5, FIG. 9 and FIG. 10, FIG. 10 is a schematic diagram showing a using state of a universal adaptor for door handle of the present disclosure. As shown in the figure, the universal adaptor 1b of the third embodiment will be taken as an example for explanation in the following, similarly, which can also be applied in the first embodiment and the second embodiment.

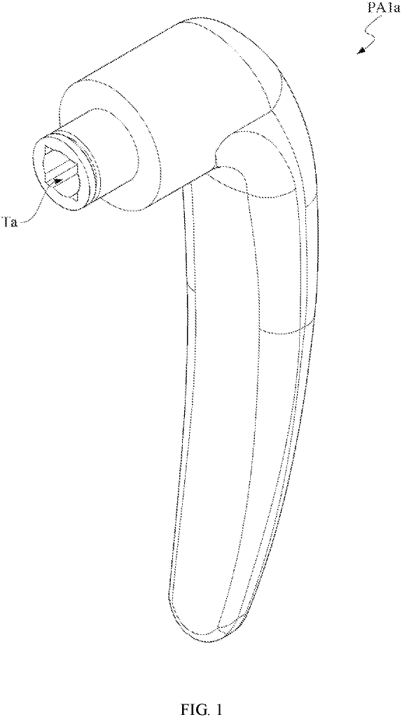

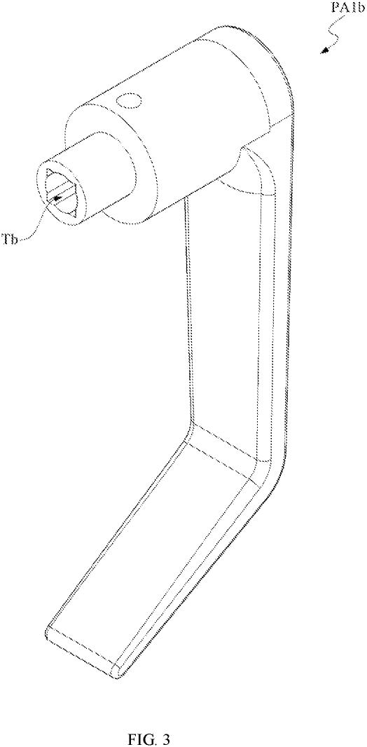

The universal adaptor 1b is used to be universally assembled in a polygonal assembling groove of one of multiple types of handles, accompanying drawings depict three handles PA1a, PA1b, PA1c with different appearances for illustration, where, handles PAla, PA1b are the handles PAla, PA1b in FIG. 1 and FIG. 3.

A catching-type fit relationship will form between the polygonal rod structure of the universal extension portion 12b and the polygonal assembling grooves Ta, Tb, Tc of the handles PA1a, PA1b, PA1c. The catching-type fit relationship indicates that the universal extension portion 12b can be operatively snap-fixed to the polygonal assembling grooves Ta, Tb, Tc, and form a catching state, so as to be connected with the handles PA1a, PA1b, PA1c; can also be operatively removed from the polygonal assembling grooves Ta, Tb, Tc under a separation state, which does not indicate that the structure of the universal extension portion 12b needs to be totally the same with the structure of the polygonal assembling grooves Ta, Tb, Tc, some tolerance can be allowed to both of them as long as that the universal extension portion 12b can be snapped into the inside of the polygonal assembling grooves Ta, Tb, Tc and be connected with the handles PA1a, PA1b, PA1c, and can be removed from the polygonal assembling grooves Ta, Tb, Tc all comply with the catching-type fit relationship.

The snap grooves T1, T2 formed on the universal extension portion 12b will be more facilitate for snapping with the polygonal assembling grooves Ta, Tb, Tc, however, the universal extension portion 12 can also be snapped with the polygonal assembling grooves Ta, Tb, Tc by using the structure itself, even the universal extension portion 12 (presented in FIG. 7) in the first embodiment is not formed with the snap grooves T1, T2. In addition, the fixing groove H2 (presented in FIG. 8) formed on the universal extension portion 12a (presented in FIG. 8) of the second embodiment can correspond to a fixing pin of the handles PA1a, PA1b, PA1c respectively, the fixing pin can be located in the polygonal assembling grooves Ta, Tb, Tc, or can penetrate into the polygonal assembling grooves Ta, Tb, Tc from the outside. For example, the circular line on the above of the handle PA1b can be regarded as that the fixing pin is penetrated from the outside to the polygonal assembling groove Tb, then is inserted into the fixing groove H2, so that the universal extension portion 12a is snapped with the handle PA1b.

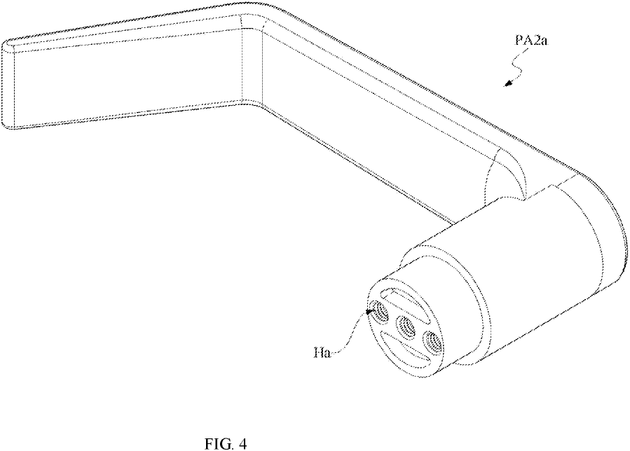

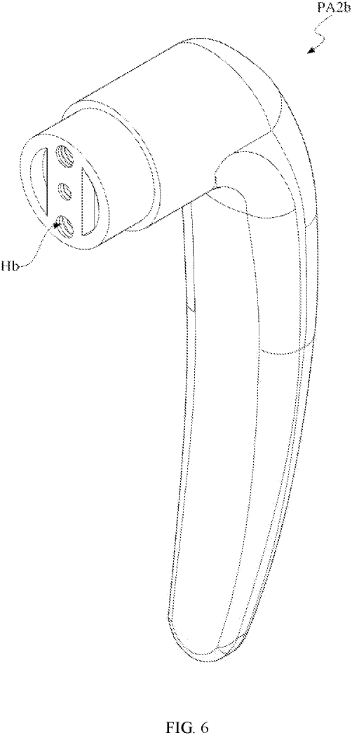

The lock hole H1 of the lock portion 11 will correspond to the panel lock L as shown in FIG. 5, so it can be locked to the lock pin P. Therefore, after the universal extension portion 12b is universally assembled in the polygonal assembling grooves Ta, Tb, Tc of the handles PA1a, PA1b, PA1c, panel-like lock handles similar with the panel lock handles PA2a, PA2b in FIG. 4 and FIG. 6 will be formed as a whole respectively, so as to make the handles PA1a, PA1b, PA1c be locked to the panel locks L respectively. It should be noted that, the panel-like lock handle refers to a handle which has the same functions with the handles PA2a, PA2b and can be locked to the panel lock L, but does not need to be manufactured by integral molding like the panel lock handles PA2a, PA2b.

Similarly, both the universal adaptor 1 (presented in FIG. 7) in the first embodiment and the universal adaptor 1a (presented in FIG. 8) in the second embodiment can also achieve the same functions and effects, so details will not be repeated.

As a summary, the universal adaptor for door handle provided by the present disclosure is universally assembled in the polygonal assembling groove of one of multiple types of handles by using the lock portion and the universal extension portion, so as to make the above-mentioned handle form a panel-like lock handle and be locked to the panel lock. Compared with the prior art, the present disclosure can be universally assembled in common handles with polygonal assembling grooves, achieve the common functions and effects, and enable the above-mentioned handles to form panel-like lock handles and are locked to panel locks, thereby resolving the problem that the handles with polygonal assembling grooves cannot be locked to the panel locks in the prior art, and the problems that different appearances require correspondingly different molds and different development costs, small quantity demanded makes the development costs a burden, overstock and backlog materials caused by minimum production requirements and various problems raised from those, all of which are caused by the panel lock handles are manufactured by integral molding.

Through the detailed description of the above-mentioned preferred embodiments, it is hoped that the characteristics and spirit of the present disclosure can be described more clearly, rather than limiting the scope of the present disclosure by the preferred embodiments disclosed above. On the contrary, the purpose is to cover various modifications and equivalent arrangements within the scope of the appended claims to be claimed by the present disclosure.

What is claimed is:

1. A universal adaptor for door handle, operable to be universally assembled in a polygonal assembling groove of one of multiple types of handles to make the handle form a panel-like lock handle applied to be locked to a panel lock, and comprising:
a lock portion, formed with at least one lock hole corresponding to the panel lock; and
a universal extension portion, connected to the lock portion and extended along an extension direction to form a polygonal rod structure, and a catching-type fit relationship is formed between the polygonal rod structure and the polygonal assembling groove.

2. The universal adaptor for door handle according to claim 1, wherein the universal extension portion further comprises an extension body, and the extension body is a polygonal body structure.

3. The universal adaptor for door handle according to claim 2, wherein the extension body is a rectangular body structure.

4. The universal adaptor for door handle according to claim 3, wherein the extension body is further formed with a fixing groove, the fixing groove is fit for a fixing pin of the handle, and is not parallel to the extension direction.

5. The universal adaptor for door handle according to claim 2, wherein the extension body is further formed with multiple snap grooves, each of the snap grooves is not parallel to the extension direction.

6. The universal adaptor for door handle according to claim 5, wherein the extension body further has a first extension plane, a second extension plane, a third extension plane and a fourth extension plane, and the multiple snap grooves are located on the first extension plane and the second extension plane.

7. The universal adaptor for door handle according to claim 6, wherein the first extension plane is adjacent to the third extension plane and the fourth extension plane, and the second extension plane is opposite to the first extension plane and is adjacent to the third extension plane and the fourth extension plane.

8. The universal adaptor for door handle according to claim 1, wherein quantity of the at least one lock hole is three, and the three lock holes are arranged along an arrangement direction.
